(19) United States
(12) Patent Application Publication
(10) Pub. No.: US 2020/0262133 A1
(43) Pub. Date: Aug. 20, 2020

(54) MAGNETOHYDRODYNAMIC JETTING OF METAL ALLOYS ON SLOPED SURFACES

(71) Applicant: XEROX CORPORATION, Norwalk, CT (US)

(72) Inventors: Scott James Vader, Pittsford, NY (US); Zachary S. Vader, Pittsford, NY (US); CHU-HENG LIU, Penfield, NY (US)

(73) Assignee: XEROX CORPORATION, Norwalk, CT (US)

(21) Appl. No.: 16/789,771

(22) Filed: Feb. 13, 2020

Related U.S. Application Data
(60) Provisional application No. 62/805,451, filed on Feb. 14, 2019.

(51) Int. Cl. B29C 64/106; B29C 64/209

(52) U.S. Cl. CPC B29C 64/106; B33Y 10/00; B29C 64/209

(57) ABSTRACT

A method of additive manufacturing includes jetting liquid material on a workpiece defining an uphill local surface and a downhill local surface. A printhead moves relative to the workpiece in a process direction, over the uphill local surface and the downhill local surface. Liquid material is jetted from the moving printhead onto the uphill local surface of the workpiece at a first predetermined spatial resolution. In a first approach, the printhead is controlled to refrain from jetting liquid material onto the downhill local surface of the workpiece. In a second approach, a local slope of the workpiece is determined, and a spatial resolution for jetting liquid material onto the local surface is determined as a function of the local slope.

### CLAIM OF PRIORITY

The present application claims priority from US Provisional Application 62/805451, filed Feb. 14, 2019.

### TECHNICAL FIELD

The present disclosure relates to drop-on-demand jetting of materials such as metals.

### BACKGROUND

U.S. Pat. Nos. 9,616,494 and 10,040,119, incorporated by reference in their entireties for the teachings thereof, describe a magnetohydrodynamic (MHD) printer and process suitable for jetting liquid metal and its alloys. The patents describe an arrangement whereby current placed through a coil produces time-varying magnetic fields that induce eddy currents within a reservoir of liquid metal compositions. Coupling between magnetic and electric fields within the liquid metal results in Lorentz forces that cause ejection of droplets of the liquid metal compositions through a nozzle of controlled size, shape, and orifice.

With the process and apparatus described in the above-mentioned patents, it is possible to jet metal onto polymer parts: the polymer may be used as a workpiece onto which metal is jetted, and then the workpiece removed when the metal is solid. Jetting of conductive traces on polymeric or metallic structures may useful in printed electronics or in the construction of batteries.

Jetting conductive trace/circuits on a non-planar/curved surface of an object presents practical challenges. More specifically, the slope of the surface, relative to the printhead or the ground, can affect the line density of the conductive traces. There are certain situations in which the conductive traces can have poor adhesion to the surface, and sometimes stay above the surface without conforming to the surface to form a desired shape.

### SUMMARY

According to one aspect, there is provided a method of additive manufacturing on a workpiece, the workpiece defining an uphill local surface and a downhill local surface. A printhead moves relative to the workpiece in a process direction, over the uphill local surface and the downhill local surface. Liquid material is jetted from the moving printhead onto the uphill local surface of the workpiece at a first predetermined spatial resolution.

According to another aspect, there is provided a method of additive manufacturing on a workpiece, the workpiece defining an uphill local surface and a downhill local surface. A printhead moves relative to the workpiece in a process direction, over the uphill local surface and the downhill local surface. A local slope of a local surface of the workpiece is determined. A spatial resolution for jetting liquid material onto the local surface is determined as a function of the determined local slope. Liquid material is jetted onto the local surface at the determined spatial resolution.

According to another aspect, there is provided a method of additive manufacturing on a workpiece comprising a polymer, the workpiece defining an uphill local surface and a downhill local surface. A downhill local slope of a downhill local surface of the workpiece is determined. Liquid material is jetted from the moving printhead onto the workpiece, the liquid material comprising at least one of aluminum and copper. The printhead is controlled to refrain from jetting liquid material onto the downhill local surface of the workpiece, if the downhill local slope exceeds a predetermined limit.

### BRIEF DESCRIPTION OF THE DRAWINGS

FIG. 1 illustrates an embodiment of a liquid metal 3D object printer, as generally known in the prior art.

FIG. 2 is a perspective view of an example workpiece on which the general apparatus shown in FIG. 1 can operate.

FIG. 3 is a sectional view of a single lobe as would be found on a non-planar workpiece for any purpose, along with elements of the liquid metal 3D object printer as shown in FIG. 1.

FIGS. 4A and 4B are simplified diagrams showing approaches in placing material droplets on a lobe such as shown in FIG. 3.

### DESCRIPTION

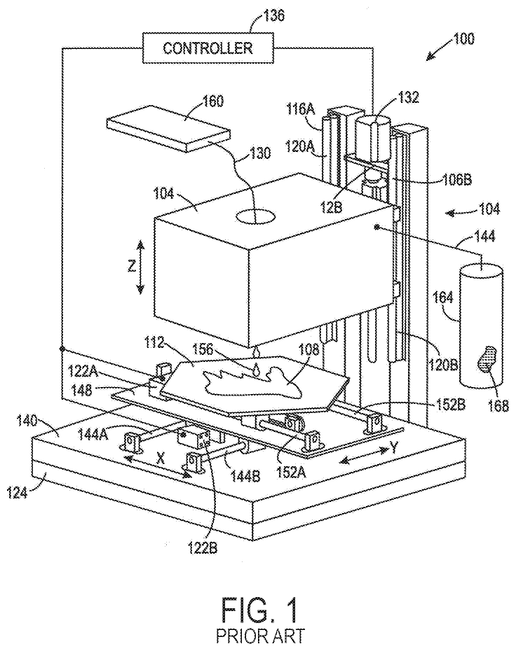

FIG. 1 illustrates an embodiment of a liquid metal 3D object printer 100. In this embodiment, drops of liquid metal are ejected from a printhead 104 and these drops form a three-dimensional metal object 108 on a platform 112. A source of metal 160 feeds metal in a form, such as metal wire 130, that is melted within printhead 104 to provide liquid metal for a chamber within the printhead. As used herein, “printhead” shall refer to an ejector that jets liquid metal or other material therefrom, possibly along with any ancillary circuitry or mechanical structure that is useful in its operation. Additionally, while the printhead 104 has only one nozzle in this embodiment, it can be configured in other embodiments with multiple nozzles.

The printhead 104 is movably mounted within z-axis tracks 116A and 116B in a pair of vertically oriented members 120A and 120B, respectively. Members 120A and 120B are connected at one end to one side of a frame 124 and at another end to one another by a horizontal member 128. An actuator 132 is mounted to the horizontal member 128 and operatively connected to the printhead 104 to move the printhead along the z-axis tracks 116A and 166B. The actuator 132 is operated by a controller 136 to maintain a predetermined distance between one or more nozzles (not shown in FIG. 1) of the printhead 104 and an uppermost surface of the object 108 on the platform 112.

Mounted to the frame 124 is a planar member 140, which can be formed of granite or other sturdy material to provide reliably solid support for movement of the platform 112. Platform 112 is affixed to X-axis tracks 144A and 144B so the platform 112 can move bidirectionally along an X-axis as shown in the figure. The x-axis tracks 144A and 1446 are affixed to a stage 148 and stage 148 is affixed to Y-axis tracks 152A and 152B so the stage 148 can move bidirectionally along a Y-axis as shown in the figure. Actuator 122A is operatively connected to the platform 112 and actuator 122B is operatively connected to the stage 148. Controller 136 operates the actuators 122A and 122B to move the platform along the X-axis and to move the stage 148 along the Y-axis to move the platform in an X-Y plane that is opposite the printhead 104. Performing this X-Y planar movement of platform 112 as drops of molten metal 156 are ejected toward the platform 112 forms a layer of a three-dimensional object such as 108.

In this embodiment, an inert gas supply 164 provides a pressure regulated source of an inert gas 168, such as argon, to the melted metal in the printhead 104 through a gas supply tube 144 to prevent the formation of aluminum oxide in the printhead.

Controller 136 also operates actuator 132 to adjust the vertical distance between the printhead 104 and the most recently formed layer to enable formation of a next object layer. While the liquid metal 3D object printer 100 is depicted in FIG. 1 as being operated in a vertical orientation, other alternative orientations can be employed. Also, while the embodiment shown in FIG. 1 has a platform that moves in an X-Y plane and the printhead moves along the Z axis, other arrangements are possible. For example, the printhead 104 can be configured for movement in the X-Y plane and along the Z axis.

The controller 136 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During object formation, image data for an image to be produced are sent to the processor or processors for controller 136 from either a scanning system or an online or work station connection for processing and generation of the printhead control signals output to the printhead 104.

The controller 136 of the liquid metal 3D object printer 100 requires data from external sources to control the printer for object formation. In general, a three-dimensional model or other digital data model of the object to be formed is stored in a memory operatively connected to the controller 136, the controller can access through a server or the like a remote database in which the digital data model is stored, or a computer-readable medium in which the digital data model is stored can be selectively coupled to the controller 136 for access. The three-dimensional model or other digital data model can be used by the controller to generate machine-ready instructions for execution by the controller 136 to operate the components of the printer 100 and fabricate the object corresponding to the model. The generation of the machine-ready instructions can include the production of intermediate models, such as when a CAD model of the object is converted into an STL data model, or other polygonal mesh or other intermediate representation, which can in turn be processed to generate machine instructions, such as g-code for fabrication of the object by the printer. As used in this document, the term “machine-ready instructions” means computer language commands that are executed by a computer, microprocessor, or controller to operate components of a 3D object additive manufacturing system to form an object. In this embodiment, the controller 136 executes the machine-ready instructions to control the ejection of the metal drops from the printhead 104, the positioning of stage 148 and the platform 112, as well as the distance between the printhead 102 and the uppermost layer of the object.

The effects of unwanted variation in one or more layers must be detected before compensation of the variation can occur. This detection requires that the size and shape of the 3D object being formed must be measured during the manufacturing process. For this purpose, one or more measurement devices 160 are operatively connected to the controller 136 and positioned to obtain image data of the object. The devices 160 can be various types of optical sensors such as two-dimensional image generating camera systems, one-dimensional line scanners when either the scanner or the part is moved relative to each other, or point sensors, which can be used for more limited, but fast measurements of various portions of a part. In some cases, captured video frames from one or more video cameras can be combined to detect part size and shape from various positions or angles. Specialized lighting techniques, such as structured light, can also be used with video construction to collect shape and size details. Lighting from various angles can also be helpful, especially for generating 3D information from shadows and reflections. These techniques have inherent tradeoffs between speed, accuracy, precision and relative amounts of useful information, and a combination of more than one type of measurement device and image data processing can be used for some applications of the compensation process and configuration of the printed object.

Once the shape and size of the object or features of the object are measured, they must be compared to the expected shape and size of the part. This comparison can be done by using various versions of the data corresponding to the part at various stages of the data processing. These various data stages include the original 3D object design, such as CAD data for the object, or a surface data format, such as an STL file. As used in this document, “object design data” means any collection of data that represents the structure of an object to be manufactured and from which machine-ready instructions are generated to operate a 3D metal object additive manufacturing system to form the metal object. The comparison can also be made between measured shape or size and a portion of the machine-ready instructions, such as the G-code for operating the printer. Use of the machine-ready instructions provide some advantages because the instructions represent the part as printed with an increased level of process detail, such as printing direction, layer number, and the like. By modifying the machine-ready instructions, subsequent layers are corrected more directly. Other versions of the ideal shape may be useful in cases where modifications in the part design are needed to compensate for some changes from what is expected in the print process, such as differences in line growth, which require regenerating the path for one or more of the printhead nozzles through one or more layers. The comparison of the shape and size measurements obtained from the image data of the object to the original 3D object design data or the machine-ready instructions identifies errors, such as vertical displacement errors.

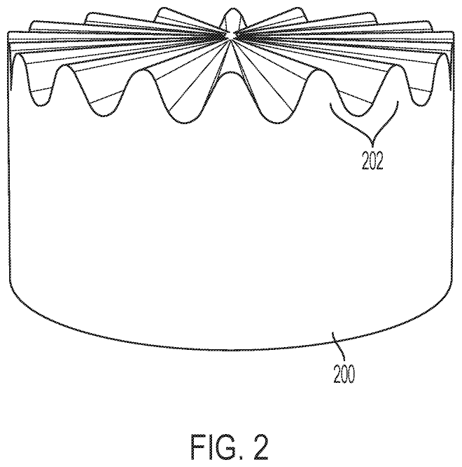

FIG. 2 is a perspective view of an example workpiece 200 on which the general apparatus shown in FIG. 1 can operate. According to an embodiment, workpiece 200 is placed, fixedly or removably as required, on platform 112 such as in the apparatus of FIG. 1, and positioned to receive, on a top surface thereof, metal droplets from printhead 104 in a manner as described above. As used herein, the term “workpiece” shall mean any member forming a surface for receiving one or more layers of jetted material. For purposes of this document, the workpiece may include previously-jetted layers of jettable material, with subsequently-jetted materials forming a new layer of material. Depending on a given desired final product, the workpiece 200 could form part of the final product or could be subsequently removed or detached from the formed layer or layers of metal or other material, leaving an object formed only of the jetted material, at least partially of a desired shape related to the receiving surface.

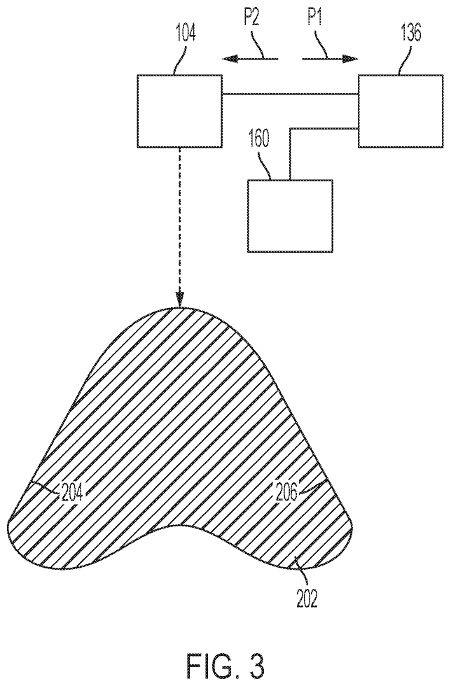

The particular workpiece 200 of FIG. 2, shown as an example, defines a number of lobes 202. FIG. 3 is a sectional view of a single lobe 202 as would be found on any non-planar workpiece for any purpose. In the course of placing molten metal or other jettable material, the lobe 202 is placed in proximity to a printhead 104, such as described above. The printhead 104 moves relative to lobe 202 as part of its normal operation, here shown as process direction P1, and opposite process direction P2, in the case of a reciprocating printhead 104 such as described above with regard to FIG. 1. (For present purposes, it is irrelevant whether printhead 104 or the workpiece 200 moves relative to the ground. Also, in other embodiments, the process directions P1, P2 need not be 180 degrees relative to each other, if the printhead 104 is capable of many angles of motion relative to the workpiece 200.)

As can be seen in the embodiment, lobe 202 includes what can be broadly called an “uphill” surface 204 and a “downhill” surface 206, in the case where printhead 104 is moving in process direction P1. Defined more precisely, an uphill local surface is a given small area in the surface of a workpiece that increases in height along the direction of printhead motion at a given time; a downhill local surface is a given small area in the surface of a workpiece that decreases in height along the direction of printhead motion at a given time. (In this discussion, any motion of the printhead 104 in the up-down Z-axis relative to workpiece 200 is irrelevant.) In an uphill local surface, the angle of rise (or slope) is a positive number; in a downhill local surface, the angle of rise (slope) is a negative number. In a greatly contoured surface of workpiece 200, the angle of rise as the printhead moves can vary continuously as the printhead 104 moves past areas of different local slopes.

In any context or material combination of workpiece and jetted material, it is generally desirable to maintain an even thickness of jetted material on all areas of the workpiece; differences in slope on the surface can result in different thicknesses or density of material. Further, in practical embodiments, such as printing conductive metal traces on a polymer such as Kapton®, the contours of the surface of a workpiece 200 can present difficulties in build quality; when printing in the “downhill” direction of a steep slope, the jetted material can have poor adhesion to the surface, or even lose contact with the surface.

According to one approach, these practical challenges can be overcome by causing the apparatus to print only on uphill local surfaces (such as 204 when the printhead 104 is moving in process direction P1) and planar (zero-slope) local surfaces, and simply refrain from printing on downhill local surfaces (such as 206 when the printhead 104 is moving in process direction P1). In the case of an apparatus with a reciprocating printhead 104, downhill local surfaces will become uphill local surfaces, eligible for jetting thereon under this approach, whenever printhead 104 reverses direction, such as from P1 to P2 in FIG. 3.

According to another approach, an apparatus can be operated to jet material at a first spatial resolution for uphill local surfaces, and at a second, different spatial resolution for downhill local surfaces. As used herein, “spatial resolution” is the number of drops (or, more broadly, amount) of jetted material per unit length of relative printhead motion. Assuming a constant velocity of the printhead 104 relative to workpiece 200, spatial resolution corresponds to the jetting frequency of the printhead 104 at a given time. (According to this definition, the refraining from jetting onto a given local surface can be considered a type of spatial resolution, i.e., a zero spatial resolution.)

According to another approach, the spatial resolution (jetted drops of material per unit length of relative printhead motion) can be varied as a function of the local slope, be it an uphill, downhill, or planar local slope. Most broadly, the spatial resolution could be made a function of the cosine of the local slope, so that a increased density of material is provided for high (positive or negative) angles of rise, relative to lower, shallower angles of rise. This approach would be robust for jetting onto complex surfaces in which the angles or rise vary continuously along a process direction. Beyond making the spatial resolution a function of cosine of the local slope, more sophisticated or nuanced algorithms for determining an effective spatial resolution for a given local area (and material sets) can be contemplated.

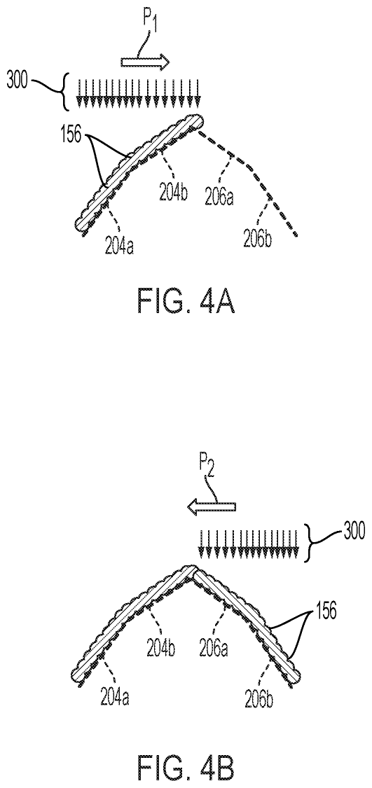

FIGS. 4A and 4B are simplified diagrams showing the above approaches in combination, in a practical embodiment. In this example, a surface includes uphill portions (from the P1 perspective) 204a and 204b, with 204a having a greater slope; there are also downhill portions 206a and 206b, with 206b having a greater slope. The groups of arrows 300 in each Figure represent the spatial resolution of jetted drops 156 as the printhead 104 moves through the process direction. In FIG. 4A, it can be seen that the spatial resolution 300 of jetted drops 156 is higher (denser) for relatively steep slope 204a, compared to slope 204b. Also, as shown in FIG. 4A, the printhead 104 can simply refrain from jetting on the downhill slopes 206a, 206b. In FIG. 4B, the printhead 104 is moved in direction P2, making slopes 206a, 206b now uphill slopes. Once again, in this case the spatial resolution 300 of jetted drops 156 is higher (denser) for relatively steep slope 206b, compared to slope 206a.

In one embodiment that is useful for jetting conductive traces onto a polymer such as Kapton®, a combination of the two above approaches is employed. In this hybrid approach, the printhead is operated to refrain from jetting on local surfaces of greater than a predetermined downhill slope. In other words, in this hybrid approach, jetting onto uphill and shallow downhill local surfaces is performed; however, no jetting is performed if the local surface is “too steep downhill,” that is, if the local downhill slope exceeds (is steeper than) a predetermined limit. Once again, if the printhead subsequently changes direction (from P1 to P2, for example), the steep downhill surface that was avoided in a first pass of printhead 104 may become an uphill surface available for jetting thereon in a subsequent pass.

In embodiments where the printhead is operated to provide a determined spatial resolution as a function of the local slope, various approaches can be provided to determine, in real time, the local slope of a local surface of the workpiece; i.e., the area of the workpiece surface that is imminently receiving jetted material from the printhead. One direct approach is to provide a sensor (ultrasound, optical, electric-field, etc.), such as 160 in FIG. 3 and generally described above with regard to FIG. 1, in the general jetting area between the printhead 104 and a surface of the workpiece 200. Such a sensor 160, could, for example, detect the changes in height of the surface of the workpiece 200 (whether or not there are previously-jetted layers of material thereon) as the printhead 104 moves relative thereto during the jetting process.

Another approach to determine a local slope of workpiece 200 is to monitor what can be generally called “operational data” of any kind. Such operational data can include the “object design data,” “machine-ready instructions,” as defined above, line-trace data, intermediate forms of such data, or combinations of different types of data, that interface with the operation of the printhead 104 to create an object of a desired design. Combinations of sensing and data-monitoring approaches may be contemplated.

With regard to practical embodiments of metal jetting, the following material combinations are possible. Precipitation hardening may be apparent when ejecting 2XXX, 6XXX, and 7XXX series Aluminum alloys. In one test, these parameters were used: 7075 Al; Nozzle diameter: 500 μm; Head Temp: 950 C; Platen Temp: 450 C; Firing Frequency: 430 Hz; Deposition Rate: 22.5 mm³/sec lb/hr). A microscopic image shows about 4 layers of build height, with no visual evidence of layer lines or boundaries where droplets fused. A comparison with cast 7075 Al and jetted 7075 Al microstructures appear to be quite similar. (The 7075 Al nominal composition was −5.6% zinc, 2.5% magnesium, and 1.6% copper, 90.3% aluminum. As-delivered 7075 wire was −5.2 zinc, 0% magnesium, and 1.4% copper, 90.3% aluminum.)

With the process and apparatus described in the above-mentioned patents, jetting of support-free structures is possible through careful control of jetting frequency and step-over distance so that previously deposited material is reasonably solidified. Much lower jetting frequencies would be used for down-facing surfaces. It is possible to generate screw-spiral toolpaths to produce lattice struts having larger diameters. Another application of the process and apparatus described in the above-mentioned patents is printed electronics and in general printed conductive traces in or on polymeric and metallic structures. Jetted aluminum and copper on a Kapton substrate heated to 200-250 C results in excellent adhesion of printed traces. Resistivity of Al 4043 is 3.24-4.16μΩ·cm for bulk 4043 (temper dependent) and 3.9μΩ·cm for 4043 feedstock wire, In one application, the 3.2-5.5μΩ·cm printed traces. Thus, the conductivity of printed aluminum traces made in this manner is very close to bulk aluminum, with excellent adhesion and flexibility.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

1. A method of additive manufacturing, comprising:
providing a workpiece, the workpiece defining an uphill local surface and a downhill local surface;
moving a printhead relative to the workpiece in a process direction, over the uphill local surface and the downhill local surface; and
jetting liquid material from the moving printhead onto the uphill local surface of the workpiece at a first predetermined spatial resolution.

2. The method of claim 1, further comprising
refraining from jetting liquid material from the moving printhead onto the downhill local surface of the workpiece.

3. The method of claim 1, further comprising
jetting liquid material from the moving printhead onto the downhill local surface of the workpiece at a second predetermined spatial resolution.

4. The method of claim 1, further comprising
determining a local slope of a local surface of the workpiece; and
determining a spatial resolution for jetting liquid material onto the local surface, as a function of the determined local slope.

5. The method of claim 4, the determining a local slope including referring to operational data.

6. The method of claim 4, the determining a local slope including detecting changes in height of the surface of the workpiece during jetting.

7. The method of claim 1, the workpiece including a previously-applied layer of material on the uphill local surface.

8. The method of claim 1, the workpiece comprising at least one of a polymer, ceramic, and metal.

9. The method of claim 1, the liquid material comprising at least one of aluminum and copper.

10. The method of claim 1, further comprising removing the workpiece to form a finished article.

11. A method of additive manufacturing, comprising:
providing a workpiece, the workpiece defining an uphill local surface and a downhill local surface;
moving a printhead relative to the workpiece in a process direction, over the uphill local surface and the downhill local surface;
determining a local slope of a local surface of the workpiece;
determining a spatial resolution for jetting liquid material onto the local surface, as a function of the determined local slope; and
jetting liquid material onto the local surface at the determined spatial resolution.

12. The method of claim 11, further comprising
jetting liquid material from the moving printhead onto the uphill local surface of the workpiece at a first predetermined spatial resolution; and
jetting liquid material from the moving printhead onto the downhill local surface of the workpiece at a second predetermined spatial resolution.

13. The method of claim 11, further comprising
refraining from jetting liquid material from the moving printhead onto the downhill local surface of the workpiece, if the downhill local slope exceeds a predetermined limit.

14. The method of claim 11, the determining a local slope including referring to operational data.

15. The method of claim 11, the determining a local slope including detecting changes in height of the surface of the workpiece during jetting.

16. The method of claim 11, the workpiece comprising at least one of a polymer, ceramic, and metal.

17. The method of claim 11, the liquid material comprising at least one of aluminum and copper.

18. A method of additive manufacturing, comprising:
providing a workpiece, the workpiece comprising a polymer, the workpiece defining an uphill local surface and a downhill local surface;
moving a printhead relative to the workpiece in a process direction, over the uphill local surface and the downhill local surface;
determining a downhill local slope of a downhill local surface of the workpiece;
jetting liquid material from the moving printhead onto the workpiece, the liquid material comprising at least one of aluminum and copper; and
refraining from jetting liquid material from the moving printhead onto the downhill local surface of the workpiece, if the downhill local slope exceeds a predetermined limit.
